(19) United States
(12) Patent Application Publication
(10) Pub. No.: US 2012/0000692 A1
(43) Pub. Date: Jan. 5, 2012

(54) SHIELDED CABLE CONNECTING STRUCTURE AND SHIELDED CABLE CONNECTING METHOD

(75) Inventor: Kazuhiko TSUCHIYA, Susono-shi (JP)

(73) Assignee: YAZAKI CORPORATION, Tokyo (JP)

(21) Appl. No.: 13/174,937

(22) Filed: Jul. 1, 2011

(30) Foreign Application Priority Data
Jul. 5, 2010 (JP) 2010-153085

(51) Int. Cl. H01B 9/02; H01R 43/00

(52) U.S. Cl. 174/107; 29/877

(57) ABSTRACT

There is provided a shielded cable connecting structure comprising a shielding layer removed portion where a plurality of covered wires are exposed for connection of connecting terminals to a shield connector and a conductive heat-shrinkable tube which is fittingly mounted on an end portion of an electromagnetic shielding layer which lies adjacent to the shielding layer removed portion and the shielding layer removed portion so as to bind together the plurality of covered wires through heat shrinkage.

### BACKGROUND OF THE INVENTION

1. Field of the Invention

The present invention relates to a shielded cable connecting structure and shielded cable connecting method for connecting a shielded cable in which an electromagnetic shielding layer which covers an outer circumference of a plurality of covered wires is formed of a conductive tape which is wound spirally around the outer circumference of the plurality of covered wires to a shield connector.

2. Related Art

JP-A-2007-194084 proposes a shielded cable in which an electromagnetic shielding layer (a shielding layer) is formed of a conductive tape which is wound spirally around an outer circumference of covered wires as a shielded cable which is highly bendable, which has superior resistance to noise and which is suitable for use in wiring on-board electronic equipment. FIG. 6 is a perspective view showing a schematic configuration of this type of shielded cable.

A shielded cable 101 includes a plurality of covered wires 103, an electromagnetic shielding layer which covers an outer circumference of the plurality of covered wires 103, a braiding 106 of a conductive metal which covers an outer circumference of the electromagnetic shielding layer 105 and an insulating sheathing 107 which covers an outer circumference of the braiding 106. The electromagnetic shielding layer 105 is formed of a conductive tape (a metallic foil tape) 108 which is wound spirally around the outer circumference of the plurality of covered wires 103. The electromagnetic shielding layer 105 is grounded via the braiding 106 and also functions as a ground wire.

In this shielded cable 101, a normal spaced distance L1 is ensured between the covered wires 103 by selecting a material and a thickness t for a covering 13a of each covered wire 103 and a tightening force of the conductive tape 108 which maintains a predetermined tight contact condition between the covered wires 103, so as to set an impedance which is closely related to a transmission performance to a predetermined value.

Next, a conventional connecting method will be described for connecting the shielded cable 101 to connecting terminals of a shield connector.

Firstly, the insulating sheathing 107 at an end portion of the shielded cable 101 at which the shielded cable 101 is connected to a shield connector is removed over a predetermined length. Further, the conductive tape 108 at the end portion is unwound so as to realize a state in which the plurality of covered wires 103 bound together are unbound individually as is shown in FIG. 6.

Following this, as is shown in FIG. 7A, connecting terminals 113 of the shield connector are connected to end portions of the covered wires 103 which are exposed from the electromagnetic shielding layer 105. Next, as is shown in FIG. 7B, the terminals which are connected to the covered wires 103 are accommodated in an inner housing 114 which is formed of an insulating resin. In the case of the shield connector shown, as is shown in FIG. 7B, a front folder 115 is mounted in the inner housing 114 for positioning front end portions of the connecting terminals 103 which are accommodated in the inner housing 114.

Next, as is shown in FIG. 7C, the conductive tape 108 which is now unwound is spirally rewound around the outer circumference of the covered wires 103 which are now unbound so as to restore the electromagnetic shielding layer 105 around the outer circumference of the plurality of covered wires 103. In addition, an adhesive tape 121 is wound around the electromagnetic shielding layer 105 in a position lying just close to the inner housing 114 for preventing the looseness of the covered wires 103 underneath the electromagnetic shielding layer 105.

Next, when a metallic shield shell, not shown, and a resin outer housing 123 are mounted on an outer circumference of the inner housing 113 as is shown in FIG. 7D, a shield connector 111 is completely built up, and at the same time as this occurs, the shield cable 101 is connected completely to the shield connector.

In the shied cable or the connecting method disclosed in JP-A-2007-194084, there are technical problems as discussed below.

As is shown in FIG. 7C, the work consumes lots of labor hours in which the electromagnetic shielding layer 105 is restored by rewinding the conductive tape 108 which is once unwound around the outer circumference of the plurality of covered wires 103, causing a problem that the working efficiency is reduced.

In addition, the fastening of the covered wires 103 by the conductive tape 108 changes depending upon the skill of working persons who rewind the conductive tape 108. As a result of this, spaces between the adjacent covered wires 103 vary, whereby the impedance of the shielded cable 101 becomes unstable at the connecting portion where the shielded cable 101 is connected to the shield connector, leading to fears that the original transmission performance cannot be obtained.

### SUMMARY OF THE INVENTION

Then, with a view to solving the problems, an object of the invention is to provide a shielded cable connecting structure which can prevent the occurrence of an unstable impedance at a connecting portion of a shielded cable in which an electromagnetic shielding layer which covers an outer circumference of a plurality of covered wires is formed of a conductive tape which is spirally wound around the outer circumference of the plurality of covered wires to a shield connector irrespective of the skill of a working person and which can increase the working efficiency in connecting the shielded cable to the shield connector.

The object of the invention will be attained by the following configurations.
(1) A shielded cable connecting structure for connecting a shielded cable to connecting terminals of a shield connector, the shielded cable comprising a plurality of covered wires, an electromagnetic shielding layer which is formed of a conductive tape which is wound spirally around an outer circumference of the plurality of covered wires and an insulating sheathing which covers an outer circumference of the electromagnetic shielding layer, the shielded cable connecting structure comprising a shielding layer removed portion where the electromagnetic shielding layer is cut to be removed over a predetermined length so as to cause the plurality of covered wires to be exposed from the electromagnetic shielding layer for connection to the connecting terminals and a conductive heat-shrinkable tube which is fittingly mounted on an end portion of the electromagnetic shielding layer which lies adjacent to the shielding layer removed portion and the shielding layer removed portion so as to bind together the plurality of covered wires through heat shrinkage.
(2) A shield cable connecting structure as set forth under (1) above, wherein the conductive heat-shrinkable tube comprises a conductive layer provided on an inner circumferential surface of a resin tube which is heat shrunk by being heated.
(3) A shielded cable connecting structure as set forth under (1) above, wherein the conductive heat-shrinkable tube is given conductivity by adding carbon in a material for the resin tube which is heat shrunk by being heated.
(4) A shielded cable connecting method for connecting a shielded cable to connecting terminals of a shield connector, the shielded cable comprising a plurality of covered wires, an electromagnetic shielding layer which is formed of a conductive tape which is wound spirally around an outer circumference of the plurality of covered wires and an insulating sheathing which covers an outer circumference of the electromagnetic shielding layer, the shielded cable connecting method comprising:

a shielding layer removing step of forming a shielding layer removed portion where the electromagnetic shielding layer is cut to be removed over a predetermined length so as to cause the plurality of covered wires to be exposed from the electromagnetic shielding layer for connection to the connecting terminals;

a terminal connecting step of connecting the connecting terminals of the shield connector to end portions of the plurality of covered wires which are exposed from the electromagnetic shielding layer; and

a tube mounting step of fittingly mounting a conductive heat-shrinkable tube which comprises a conductive layer provided on an inner circumferential surface of a resin tube which is heat shrunk by being heated on an end portion of the electromagnetic shielding layer which lies adjacent to the shielding layer removed portion and the shielding layer removed portion and thereafter heat shrinking the conductive heat-shrinkable tube so as to produce a state in which the plurality of covered wires are bound together.

According to the configuration described under (1) above, the individual covered wires at the shielding layer removed portion from which the electromagnetic shielding layer is removed for connection to the connecting terminals of the shield connector can be put back to the bound state by heat shrinking the conductive heat-shrinkable tube. In addition, when the heating temperature and the heating time during which the conductive heat-shrinkable tube is heat shrunk are set to appropriate values, the shielding layer removed portion can be formed into a bound state (a fastened state) which is similar to that within the normal electromagnetic shielding layer irrespective of the skill of the working person. Additionally, the conductive heat-shrinkable tube is provided, and therefore, an electromagnetic shielding performance (a shielding performance) similar to that of the normal electromagnetic layer can also be ensured around the circumference of the shielding layer removed portion. Namely, the conductive heat-shrinkable tube which encompasses the shielding layer removed portion implements a similar function to that of the normal electromagnetic shielding layer.

Consequently, the occurrence of unstable impedance at the connecting portion of the shielded cable to the shield connector can be prevented irrespective of the skill of the working person.

Further, the work of mounting the conductive heat-shrinkable tube on the shielding layer removed portion involves much fewer labor hours than the work of restoring the electromagnetic shielding layer by rewinding the conductive tape spirally around the outer circumference of the covered wires. Therefore, the working efficiency at which the shielded cable is connected to the shield connector can also be increased.

According to the configurations described under (2) and (3) above, the conductive heat-shrinkable tube can be provided with the simple configuration.

According to the configuration described under (4) above, the shielded cable connecting structure described under (1), (2) and (3) can be formed in an ensured fashion.

According to the shielded cable connecting structure of the invention, the conductive heat-shrinkable tube which encompasses the shielding layer removed portion implements a similar function to that of the normal electromagnetic shielding layer. Because of this, the occurrence of unstable impedance at the connecting portion of the shielded cable to the shield connector can be prevented irrespective of the skill of the working person.

Further, the work of mounting the conductive heat-shrinkable tube on the shielding layer removed portion involves much fewer labor hours than the work of restoring the electromagnetic shielding layer by rewinding the conductive tape spirally around the outer circumference of the covered wires. Therefore, the working efficiency at which the shielded cable is connected to the shield connector can also be increased.

### BRIEF DESCRIPTION OF THE DRAWINGS

FIG. 1 is a perspective view of an embodiment of a shield connector to which a shielded cable shown in FIG. 6 is connected according to a shielded cable connecting structure of the invention.

FIG. 2 is an exploded perspective view of the shield connector shown in FIG. 1.

FIGS. 3A to 3D show explanatory diagrams depicting a shielded cable connecting method when the shielded cable is connected to the shield connector shown in FIG. 1.

FIG. 4 is a perspective view of a conductive heat-shrinkable tube for use in the shielded cable connecting method shown in FIG. 3.

FIG. 5 is a perspective view of a heating apparatus which heat shrinks the conductive heat-shrinkable tube shown in FIG. 4.

FIG. 6 is a perspective view of the shielded cable which is connected to the shield connector according to the shielded cable connecting structure of the invention.

FIGS. 7A to 7D show explanatory diagrams depicting a conventional shielded cable connecting method for connecting the shielded cable shown in FIG. 6 is connected to the shield connector.

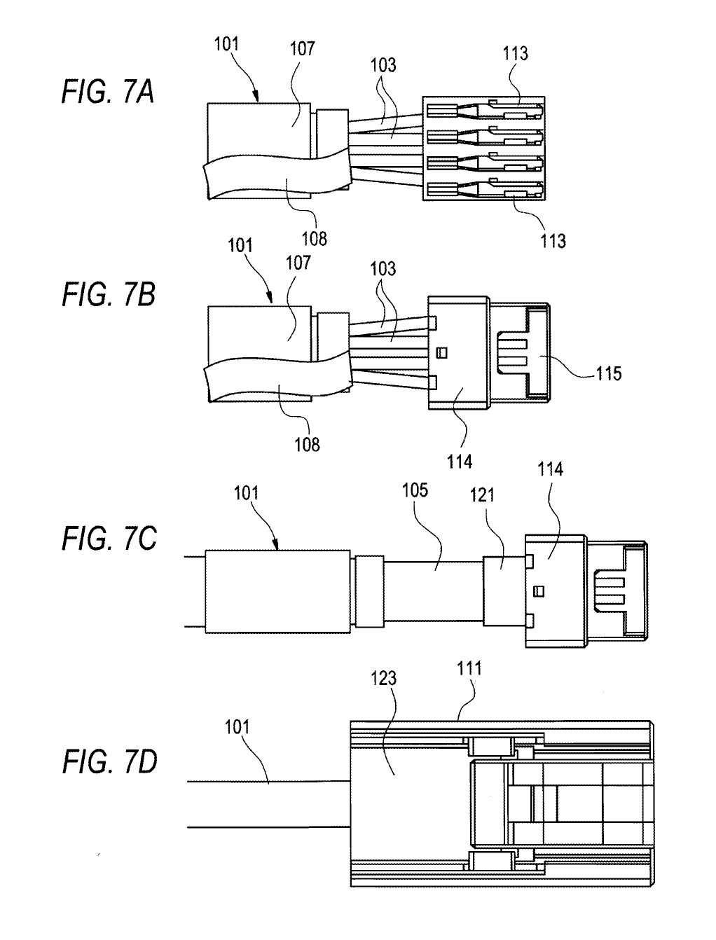

### DETAILED DESCRIPTION OF THE PREFERRED EMBODIMENTS

Hereinafter, preferred embodiments of a shielded cable connecting structure and a shielded cable connecting method according to the invention will be described in detail by reverence to the drawings.

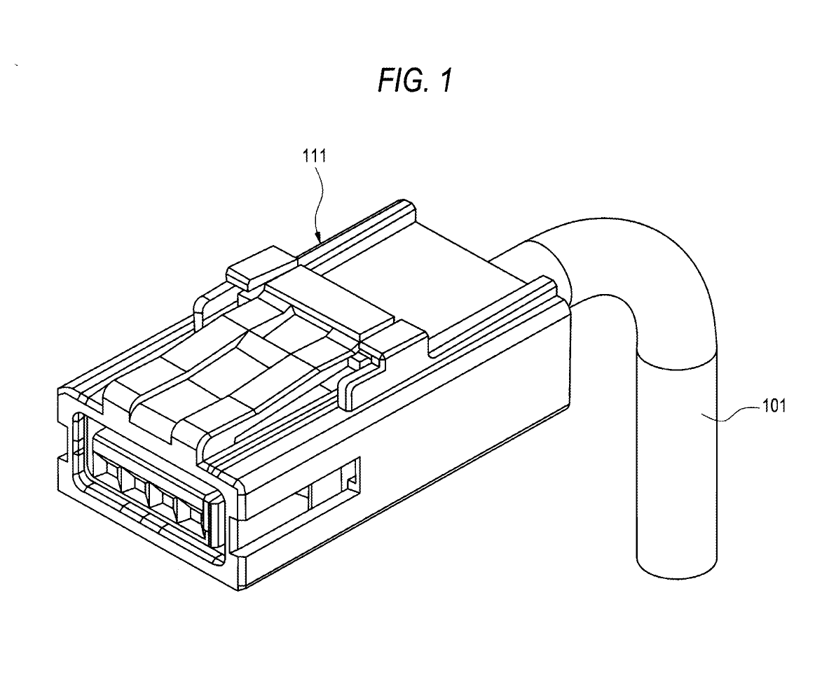

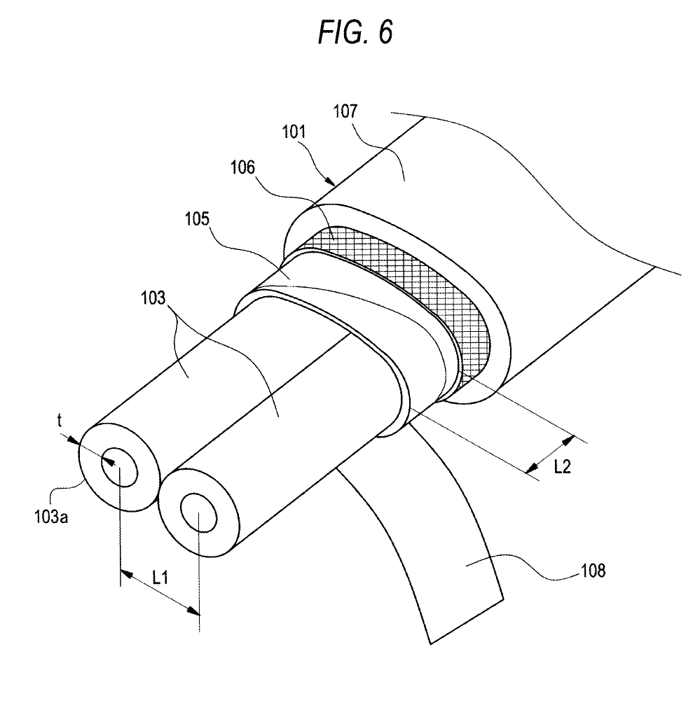

FIG. 1 is a perspective view of an embodiment of a shield connector 111 to which a shielded cable 101 shown in FIG. 6 is connected according to a shielded cable connecting structure of the invention.

As is shown in FIG. 6, the shielded cable 101 includes a plurality of covered wires 103, an electromagnetic shielding layer 105 which covers an outer circumference of the plurality of covered wires 103, a braiding 106 which is formed of a conductive metal and which covers an outer circumference of the electromagnetic shielding layer 105 and an insulating sheathing 107 which covers an outer circumference of the braiding 106. The electromagnetic shielding layer 105 is formed of a conductive tape (a metallic foil tape) 108 which is wound spirally around the outer circumference of the plurality of covered wires 103. The electromagnetic shielding layer 105 is grounded via the braiding 106 and also functions as a ground wire.

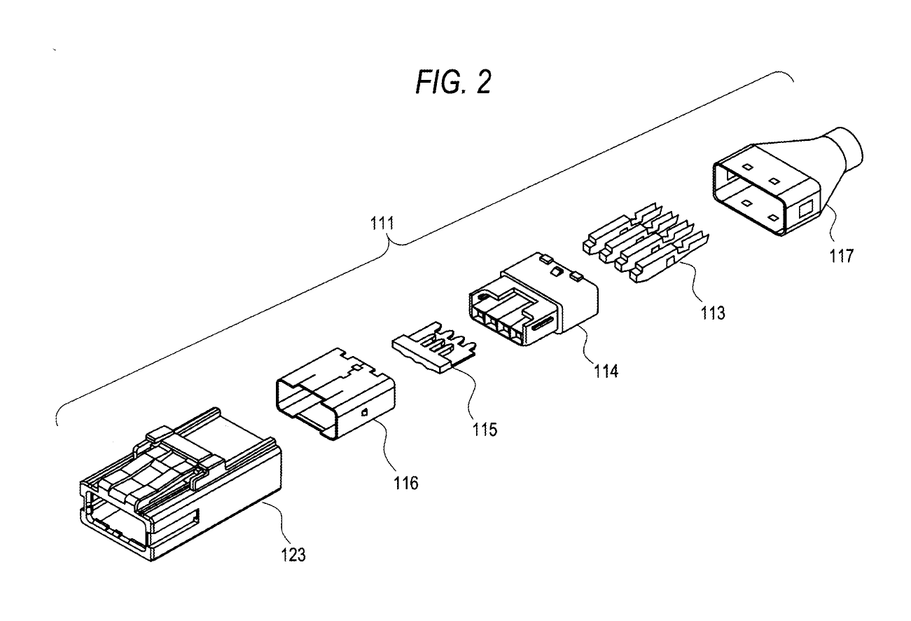

As is shown in FIG. 2, the shield connector 111 includes a plurality of connecting terminals 113 which are each made of a metallic plate and to which conductors of the covered wires 103 are connected in a solderless fashion, an inner housing 114 which is formed of an insulating resin and which accommodates therein the plurality of connecting terminals 113, a front holder 115 which is fittingly mounted in a front end portion of the inner housing 114 to position front end portions of the connecting terminals 113 within the inner housing 114, an angularly cylindrical front shield shell 116 which is fittingly mounted on an outer circumference of a front end side of the inner housing 114, a rear shield shell 117 which is fittingly mounted on an outer circumference of a rear end side of the inner housing 114 and an outer housing 123 which is formed of an insulating resin and which accommodates therein the front shield connector 116 and the rear shield connector 117 so as to provide an external appearance of the shield connector 111.

Next, a shielded cable connecting method for connecting the shielded cable 101 shown in FIG. 6 to the shield connector 111 shown in FIG. 2 will be described.

Firstly, the insulating sheathing 107 is removed over a predetermined length at an end portion of the shielded cable 101 which is to be connected to the shield connector 111.

Next, the following steps will sequentially be implemented in the order in which they will be described. The steps are a shielding layer removing step, a terminal connecting step, an inner housing assembling step, a tube mounting step and a final connector assembling step.

In the shielding layer removing step, the conductive tape 108 is unwound at the end portion of the shielded cable 101 where the insulating sheathing 107 and the braiding 106 are removed so as to produce a state in which the binding of the covered wires 103 is released as is shown in FIG. 6. As this occurs, as is shown in FIG. 6, the conductive tape 108 is unwound over a predetermined length so that the electromagnetic shielding layer 105 based on the conductive tape 108 wound remains by an appropriate length L2 from an end portion of the insulating sheathing 107. A shielding layer removed portion 131 is formed by this shielding layer removing step where the plurality of covered wires 103 are exposed over a predetermined length L3 from an end portion of the electromagnetic shielding layer 105 as is shown in FIG. 6.

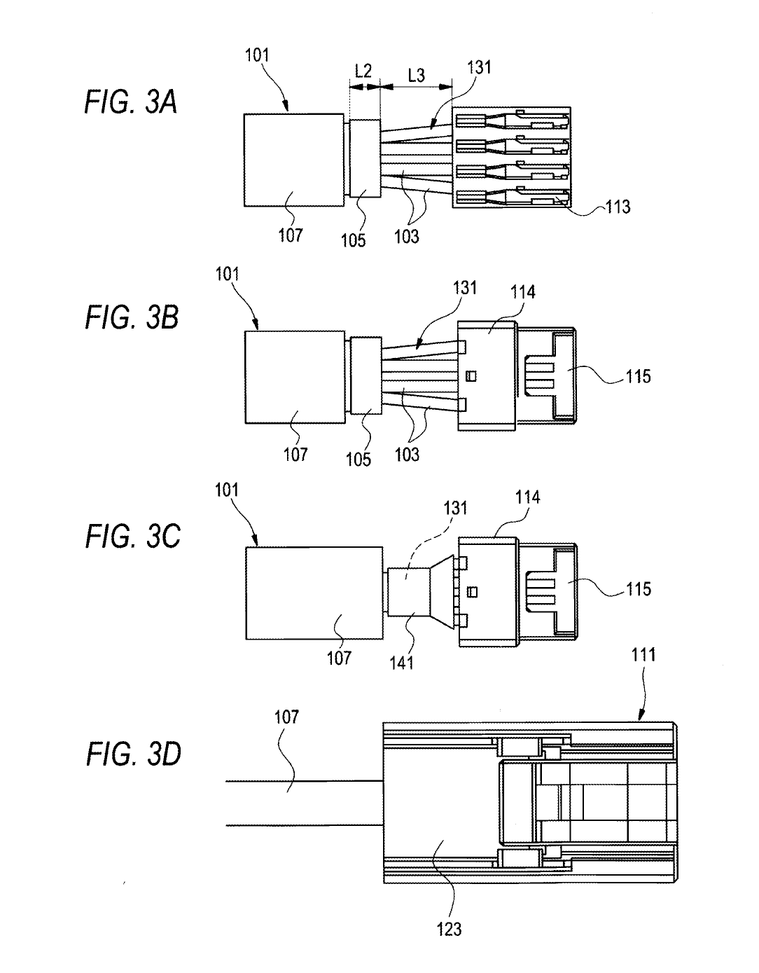

In the terminal connecting step, as is shown in FIG. 3A, the connecting terminals 113 shown in FIG. 2 are connected individually to end portions of the plurality of covered wires 103 which are exposed from the electromagnetic shielding layer 105.

The inner housing assembling step is a step of accommodating the connecting terminals 113 which are now connected individually to the covered wires 103 in the inner housing 114 shown in FIG. 2, as is shown in FIG. 3B. In addition, in this step, the front holder 115 shown in FIG. 2 is mounted in a front end portion of the inner housing 114, so as to fix the connecting terminals 113 within the inner housing 114 in place.

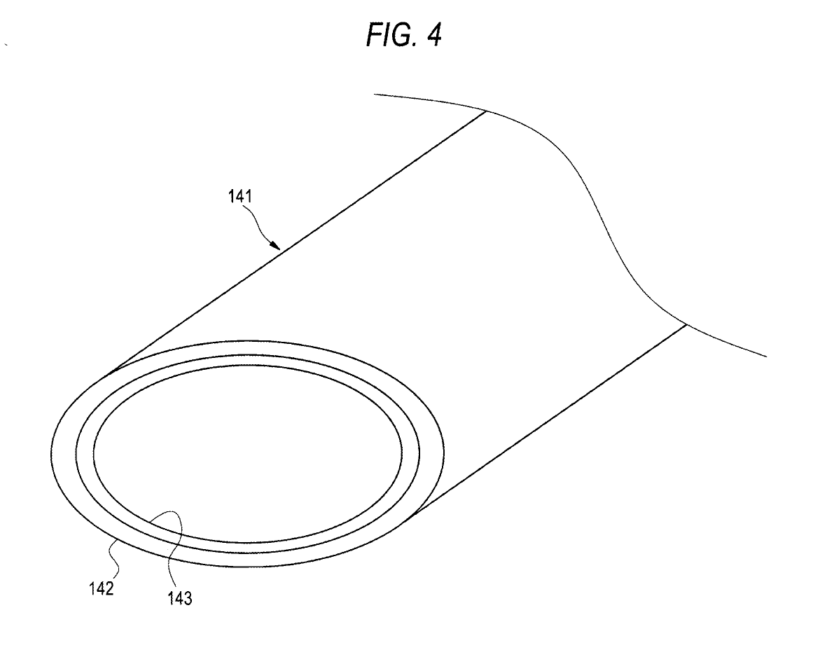

In the tube mounting step, a conductive heat-shrinkable tube 141 shown in FIG. 4 is fittingly mounted on the end portion of the electromagnetic shielding layer 105 which lies adjacent to the shielding layer removed portion 131 and the shielding layer removed portion 131. Thereafter, the conductive heat-shrinkable tube 141 is heat shrunk so that the plurality of covered wires 103 at the shielding layer removed portion 131 are bound together.

The conductive heat-shrinkable tube 141 is made by providing a conductor layer 143 on an inner circumferential surface of a resin tube 142 which is heat shrunk when heated. The conductor layer 143 is formed of, for example, a conductive cloth which is affixed to the inner circumferential surface of the resin tube 142.

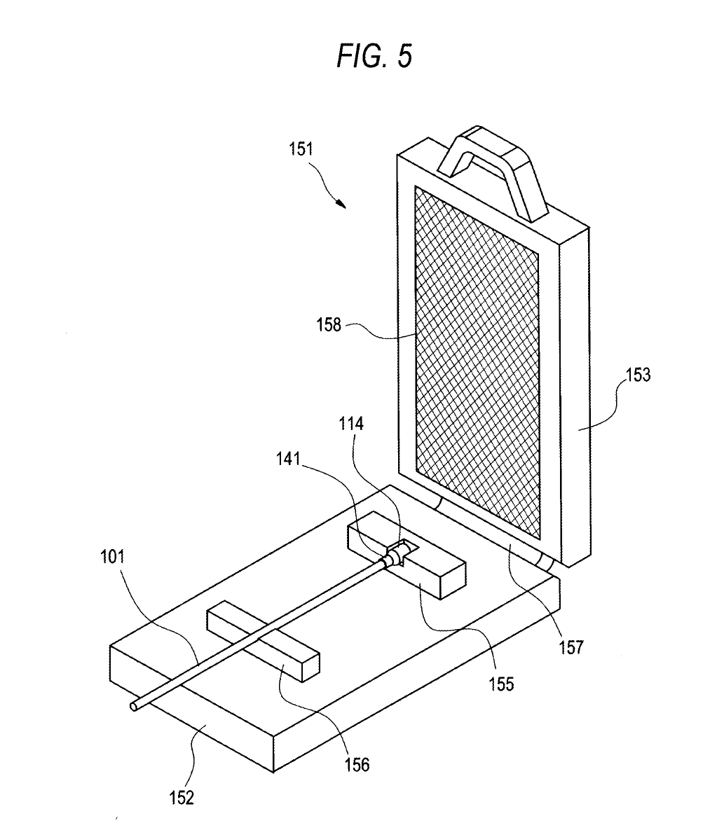

The conductive heat-shrinkable tube 141 is heated by a heating apparatus 151 shown in FIG. 5. The heating apparatus 151 includes a resting table 152 which positions the inner housing 114 and the shielded cable 101 which are shown in FIG. 3C and a heater 153 which heats the conductive heat-shrinkable tube 141 on the shielded cable 101 which is rested on the resting table 152.

The resting table 152 includes a housing fixing jig 155 which positions the inner housing 114 and a cable fixing jig 156 which positions the shielded cable 101.

The heater 153 is connected to one end side of the resting table 152 by a hinge 157 so as to be opened and closed. FIG. 5 shows a state in which the heater 153 is opened. The heater 153 is configured so that heating wires 158 for heating the conductive heat-shrinkable tube 141 are disposed in a side thereof which is placed over the resting table 152 when the heater 153 is closed.

When a shield tube manufactured by Zippertubing (Japan), Ltd. and marketed under the trade name of SS Tube SS-6 is used for the conductive heat-shrinkable tube 141, a predetermined shrinkage is attained by heating the shield tube for five seconds at 80° C. by the heater 153, whereby the plurality of covered wires 103 which are accommodated therein are fastened together in an appropriate fashion. Here, the appropriately fastened state means a state in which the plurality of covered wires 103 are fastened together with a fastening force which is equal to the fastening force applied by the electromagnetic shielding layer 105 inside the insulating sheathing 107 of the shielded cable 101.

The final connector assembling step is a step of completing the assemblage of the shield connector 111 as is shown in FIG. 3D by assembling the front shield shell 116 and the rear shield shell 117, which are shown in FIG. 2, on the outer circumference of the inner housing 114 and the conductive heat-shrinkable tube 141, which are shown in FIG. 3C, and assembling further the outer housing 123 on the outside of these shells 116, 117.

In the shielded cable connecting method of the embodiment that has been described heretofore, the connecting portion of the shielded cable 101 to the shield connector 111 takes the connecting structure which includes, as is shown in FIG. 3C, the shielding layer removed portion 131 where the plurality of covered wires 103 are exposed from the electromagnetic shielding layer 105 and the conductive heat-shrinkable tube 141 which is fittingly mounted on the end portion of the electromagnetic shielding layer 105 which lies adjacent to the shielding layer removed portion 131 and the shielding layer removed portion 131 and which binds together the plurality of covered wires 103 through heat shrinkage.

According to the shielded cable connecting structure, the individual covered wires 103 at the shielding layer removed portion 131 from which the electromagnetic shielding layer 105 is removed can be put back to the bound state by heat shrinking the conductive heat-shrinkable tube 141. In addition, when the heating temperature and the heating time during which the conductive heat-shrinkable tube 141 is heat shrunk are set to appropriate values, the shielding layer removed portion 131 can be formed into a bound state (a fastened state) which is similar to that within the normal electromagnetic shielding layer 105 irrespective of the skill of the working person. Additionally, an electromagnetic shielding performance (a shielding performance) similar to that of the normal electromagnetic layer 105 can also be ensured around the circumference of the shielding layer removed portion 131 because the conductive heat-shrinkable tube 141 includes the conductor layer 143 on the inner circumferential surface thereof. Namely, the conductive heat-shrinkable tube 141 which encompasses the shielding layer removed portion 131 implements a similar function to that of the normal electromagnetic shielding layer 105.

Consequently, the occurrence of unstable impedance at the connecting portion of the shielded cable 101 to the shield connector 111 can be prevented irrespective of the skill of the working person.

Further, the work of mounting the conductive heat-shrinkable tube 141 on the shielding layer removed portion 131 involves much fewer labor hours than the work of restoring the electromagnetic shielding layer 105 by rewinding the conductive tape 108 spirally around the outer circumference of the covered wires 103. Therefore, the working efficiency at which the shielded cable 101 is connected to the shield connector 111 can also be increased.

The shielded cable connecting structure and the shielded cable connecting method of the invention are not limited to the embodiment that has been described heretofore but can be modified or improved variously. In addition, the number of covered wires in the shielded cable and the dimensions of the shielding layer removed portion and the conductive heat-shrinkable tube which are described in the embodiment are not limited to those of the embodiment but are arbitrary, provided that the object of the invention can be attained by them.

For example, the conductive heat-shrinkable tube may be such that carbon is contained in a material for a heat-shrinkable tube so as to give it conductivity.

What is claimed is:

1. A shielded cable connecting structure comprising:
a plurality of covered wires;
an electromagnetic shielding layer which is formed of a conductive tape which is wound spirally around an outer circumference of the plurality of covered wires;
an insulating sheathing which covers an outer circumference of the electromagnetic shielding layer;
a shielded cable to connecting terminals of a shield connector to which the shield cable is connected;
a shielding layer removed portion where the electromagnetic shielding layer is cut to be removed over a predetermined length so as to cause the plurality of covered wires to be exposed from the electromagnetic shielding layer for connection to the connecting terminals; and
a conductive heat-shrinkable tube which is fittingly mounted on an end portion of the electromagnetic shielding layer which lies adjacent to the shielding layer removed portion and the shielding layer removed portion so as to bind together the plurality of covered wires through heat shrinkage.

2. A shield cable connecting structure as set forth in claim 1, wherein the conductive heat-shrinkable tube comprises a conductive layer provided on an inner circumferential surface of a resin tube which is heat shrunk by being heated.

3. A shielded cable connecting structure as set forth in claim 1, wherein the conductive heat-shrinkable tube is given conductivity by adding carbon in a material for the resin tube which is heat shrunk by being heated.

4. A shielded cable connecting method for connecting a shielded cable to connecting terminals of a shield connector, the shielded cable comprising a plurality of covered wires, an electromagnetic shielding layer which is formed of a conductive tape which is wound spirally around an outer circumference of the plurality of covered wires and an insulating sheathing which covers an outer circumference of the electromagnetic shielding layer, the shielded cable connecting method comprising:
a shielding layer removing step of forming a shielding layer removed portion where the electromagnetic shielding layer is cut to be removed over a predetermined length so as to cause the plurality of covered wires to be exposed from the electromagnetic shielding layer for connection to the connecting terminals;
a terminal connecting step of connecting the connecting terminals of the shield connector to end portions of the plurality of covered wires which are exposed from the electromagnetic shielding layer; and
a tube mounting step of fittingly mounting a conductive heat-shrinkable tube which comprises a conductive layer provided on an inner circumferential surface of a resin tube which is heat shrunk by being heated on an end portion of the electromagnetic shielding layer which lies adjacent to the shielding layer removed portion and the shielding layer removed portion and thereafter heat shrinking the conductive heat-shrinkable tube so as to produce a state in which the plurality of covered wires are bound together.
